(19) United States
(12) Patent Application Publication
(10) Pub. No.: US 2017/0290465 A1
(43) Pub. Date: Oct. 12, 2017

(54) FUEL SOURCE COMBUSTION ASSEMBLY AND COOKING APPARATUS

(71) Applicant: Jebco, Inc., Warrenton, GA (US)

(72) Inventor: James A. Barrow, Warrenton, GA (US)

(21) Appl. No.: 15/475,712

(22) Filed: Mar. 31, 2017

Related U.S. Application Data
(60) Provisional application No. 62/315,845, filed on Mar. 31, 2016.

(51) Int. Cl. A47J 37/07; F24B 13/04

(52) U.S. Cl. CPC A47J 37/0704; A47J 37/0786; F24B 13/04

(57) ABSTRACT

A fuel source combustion assembly is configured to allow for easy and safe reloading of a pre-ignited fuel source, in particular charcoal, into a cooking apparatus, such as a smoker, barbecue grill, indoor cooker, and the like. The assembly has a housing, to an inside of which a hamper is installed so as to be able to rotate through an opening on an outside wall of the housing. While in the rotated position, hamper is configured to present a rectangular opening, into which the fuel source may be poured. After the hamper is loaded, it can be rotated so as to be back inside of housing to be secured securely (e.g., by an external door).

### CROSS REFERENCE TO RELATED APPLICATIONS

This application claims the benefit of and priority to U.S. Provisional Patent Application Ser. No. 62/315,845, filed Mar. 31, 2016, the disclosure of which is incorporated herein by reference in its entirety.

### TECHNICAL FIELD

The presently disclosed subject matter relates to a hamper assembly for containment of a fuel source, a cooking apparatus having such a hamper assembly, and a method of reloading a fuel source in a cooking apparatus.

### BACKGROUND

It has long been popular to cook food, particularly meat, on grills, barbecues, rotisseries, smokers, and the like using fuel types (e.g., charcoal, wood chips, etc.) that must be replenished frequently. However, where long cook times (e.g., multiple hours) are needed, it is often necessary to refresh and/or replenish the fuel during cooking, without stopping or significantly interrupting the cooking process. In some instances, the fuel being added is already burning (e.g., charcoal started in a charcoal chimney) when it is added. Existing smokers, cookers, barbecue grills, and the like that utilize charcoal or other combustible heat sources are not configured to allow the charcoal to be easily added to the fire box or heating portion of the smoker, particularly when the charcoal or other combustible fuel source is pre-ignited. This can be true whether the cooking is accomplished via direct or indirect heating methods. It is particularly challenging, and indeed dangerous, to add hot or burning coals to existing smokers. Furthermore, the conventional process requires significant time and care by the operator to avoid being burned, during which time the heat produced within the chamber can escape via the access hatch that is opened for refueling.

As such, a need exists for improved devices, apparatuses, and methods for replenishing the fuel within a cooking device in order to speed the process and prevent injuries that could otherwise be avoided. Thus, provided herein is a hamper assembly that allows a user to easily and safely replenish a fuel source (e.g., burning charcoal) in a smoker, cooker, barbecue grill, and the like.

### SUMMARY

Provided herein are devices and assemblies for a fuel source combustion assembly and a method for loading a combustible fuel source in a cooking apparatus.

According to one aspect, a fuel source combustion assembly for use in a cooking apparatus is provided. This assembly includes a fuel source hamper configured to receive and contain a combustible fuel source therein; a housing configured to at least partially surround the hamper, the housing having an opening on an external surface thereof, through which the hamper is accessible; and a door disposed on an external surface of the housing and configured to move between an open position and a closed position with respect to the housing and hamper, wherein, when the door is in the closed position, the opening in the housing is substantially entirely covered by the door and, when the door is in the open position, the hamper is accessible to a user through the opening in the housing. The hamper is mounted to the housing at one or more hinge points, and at least a portion of the hamper is configured to tilt through and out of the opening in the housing by rotating, with respect to the housing, at the one or more hinge points.

According to another aspect, a hamper configured to receive and contain combustible fuel source therein is provided. According to this aspect, the container has a shape of a substantially square or rectangular shaped box with an at least partially open top; a bottom with perforations or one or more openings configured for air to flow therethrough to the fuel source and for combustion remnants of the fuel source to pass therethrough out of the hamper; four side walls connected to the bottom; and two pins mounted on the container so the container is rotatably connectable to a cooking apparatus.

According to yet another aspect, a method of loading a combustible fuel source into a cooking apparatus is provided. According to this aspect, the method includes providing a cooking apparatus, which has a fuel source combustion assembly, the fuel source combustion assembly having a hamper configured to receive and contain a combustible fuel source, and a housing configured to at least partially surround the hamper, the housing comprising an opening on an external surface thereof, through which the hamper is accessible; rotating or tilting the hamper from a first position to a second position, so the hamper, during the rotating or tilting, passes at least partially through and out of the opening by rotating or tilting about a hinge axis defined by one or more hinge points by which the hamper is rotatably connected to the housing; loading the combustible fuel source into the hamper; and rotating or tilting the hamper from the second position to the first position.

Embodiments of the presently disclosed subject matter having been stated hereinabove, and which is achieved in whole or in part by the presently disclosed subject matter, other embodiments will become evident as the description proceeds when taken in connection with the accompanying Examples as best described hereinbelow.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the following figures (“FIGS.”), in which:

FIG. 1 is a schematic side view of an embodiment of a fuel source combustion assembly in a loading arrangement, in accordance with the disclosure herein;

FIG. 2 is a schematic side view of the fuel source combustion assembly shown in FIG. 1, but in a cooking arrangement, in accordance with the disclosure herein;

FIG. 3 is a schematic external front view of the fuel source combustion assembly in the cooking arrangement shown in FIG. 2, in accordance with the disclosure herein;

FIG. 4 is a schematic partial front internal view of the fuel source combustion assembly shown in FIG. 3, in accordance with the disclosure herein;

FIG. 5 is a perspective external view of the fuel source combustion assembly installed in a cooking apparatus, in accordance with the disclosure herein;

FIG. 6 is a perspective view of the fuel source combustion assembly installed in a cooking apparatus corresponding to FIG. 5, but with the door open, in accordance with the disclosure herein;

FIG. 7 is a perspective external view of the fuel source combustion assembly installed in a cooking apparatus, with the fuel source combustion assembly being in a loading arrangement, in accordance with the disclosure herein;

FIG. 8 is a perspective top internal view of the fuel source combustion assembly installed in a cooking apparatus corresponding to the arrangement shown in FIG. 6, in accordance with the disclosure herein;

FIG. 9 is an external front view of an example cooking apparatus, including a fuel source combustion assembly, in accordance with the disclosure herein.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only, and is not intended to be interpreted as in any way limiting the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a tool” includes a plurality of such tools, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and individually, but also includes any and all combinations and subcombinations of A, B, C, and D.

In some embodiments a fuel source combustion assembly is installed in a cooking apparatus, including, for example, a smoker, a barbecue grill, and any other device configured to cook and/or smoke a food product placed therein. This assembly, as provided herein, can comprise a hamper in the form of a box having a bottom and four sides, with an open top. In some such embodiments, the hamper in the form of a box will have a profile in the shape of a square or rectangle. In other embodiments, the hamper may be in any suitable form that would allow for containment of a combustible fuel source during the combustion thereof. The hamper is configured to receive and contain a combustible fuel source therein; in some embodiments, this fuel source includes, for example, one or more of charcoal, woof, fuel pellets, and the like. The hamper can be mounted in a housing, which surrounds, at least partially, the hamper. The hamper has an opening on an outwardly-facing wall of the assembly in order for the hamper to be accessible by a user of the cooking apparatus. In some embodiments, the housing substantially encloses the hamper, other than at the outwardly-facing wall of the hamper and for an exhaust port. The housing can reside entirely or substantially inside a cooking apparatus. In some embodiments the hamper can be attached to the housing in a manner that allows the hamper to rotate or tilt outward; at least to some degree, in order to enable easy reloading of the combustible fuel source. In some of these embodiments, the attachment is made as a hinge or pivot point. In some embodiments the hamper housing can include a hinge support member on the lateral sides of the hamper, each of which provides a hinge slot configured to receive a hinge pin associated with the hamper to thereby provide a hinge point configured to allow the coal hamper to rotate or tilt outward from the interior of the smoker. In some embodiments, the hinge pin may be a single piece across a width of the hamper. In other embodiments, the hinge pin may be formed as two discrete pieces, either affixed to or integral with the hamper. In still other embodiments, the hinge pin may be on a front surface of the hamper, rather than a lateral side thereof, without hindering the pivoting or tilting movement of the hamper. As discussed briefly above, the assembly can be mounted on or at an outer surface or wall of a cooking apparatus and extend into, at least partially, the interior of the cooking apparatus to provide a container to hold a fuel source undergoing combustion and, further, to direct heat and/or smoke from the fuel source into a cooking chamber of the cooking apparatus during use.

In some embodiments the bottom of the hamper can include one or more perforations or openings (e.g., holes of any suitable size and shape). These perforations or openings are configured to allow air to flow through the fuel source from an area underneath the hamper to aid in combustion of the charcoal. For example, the bottom of the hamper can comprise expanded metal or some other suitable perforated metal. These air flow perforations or openings may be provided in one or more of the side walls of the hamper, either in lieu of, or in addition to, any such perforations or openings in the bottom of the hamper.

In some embodiments the housing comprises, as noted briefly above, one or more exhaust ports which can, for example, be located at the top edge of the rear wall of the housing. This exhaust port is, in some embodiments, configured to direct a flow of combustion gases (e.g., smoke) and heat produced during combustion of the fuel source from the housing into the cooking chamber of the smoker. In some embodiments an ash pan can be included, mounted below the hamper so as to catch any combustion remnants (e.g., ashes) falling from the hamper via the one or more perforations and/or openings in the bottom of the hamper. The ash pan can, in some aspects, be configured to be slidably removable from the portion of the housing that is underneath the hamper for easy removal and disposal of the combustion remnants. Removal of the ash pan can be accomplished via travel of the ash pan on one or more rails, a sliding frictional interface (e.g., the ash pan on a flat bottom surface of the housing), or any other such suitable movement; as would be understood by those having ordinary skill in the art.

In some embodiments the disclosed coal hamper assembly can comprise an outer door configured to be mounted on an outer surface or wall of the cooking apparatus. This door can; in some aspects, be configured to provide a covering or door-like structure that covers or encloses the opening in the outwardly-facing wall of the housing, through which the hamper is accessible by a user. The door can be mounted to the wall or outer external surface of the cooking apparatus by any suitable fastener; including; for example, but not limited to, bolts, screws, rivets, pins, welds; solders, etc. In some aspects the door can be mounted to an outer frame, with the outer frame being attached or secured to the outer wall of the cooking apparatus in a similar manner as is described above for fastening of the door. The door can be attached to the outer frame such that the door is movable between the open and closed positions via a hinge, while still being supported at one or more edges by the outer frame. In some embodiments, when the door is open, the hamper can be accessed by, for example, a tilting or pivoting movement of the door in an outward direction away from the cooking apparatus; by this movement; a user is able to tend the fire; add pre-ignited charcoal, and/or add any other additional fuel materials.

In some embodiments the door and/or a combined door and outer frame assembly, can include one or more door latches to secure the door in a closed position. In some embodiments the door can comprise one or more door vents (e.g., shutters or louvered openings) configured to control air flow into the cooking apparatus and, particularly, into the portion of the assembly where the hamper is located. In some embodiments, vents or shutters can be located at one or more other locations on the cooking apparatus (e.g.; a cooking chamber) and/or assembly to control air flow into the cooking apparatus.

While in use, a user can open the door and pivot or tilt open the hamper to add the combustible fuel source (e.g., charcoal), even hot or pre-ignited charcoal, to the hamper. Since the hamper is able to pivot and/or tilt outwardly from the assembly and/or cooking apparatus, the user can easily and safely add a pre-ignited fuel source (e.g., pre-ignited charcoal from a chimney starter) by simply pouring it into the hamper. The hamper can then be safely tilted back to a closed position, thereby safely ensuring the coals are loaded inside the cooking apparatus. The door can then be closed and secured via the one or more latches. Opening or closing the one or more door vents allows for control of the air flow to the fuel source in the hamper.

In some embodiments, the hamper, housing, ash pan, outer door, door vents, and/or door frame are made of a metal alloy, aluminum, steel, cast iron, stainless steel, and the like, or any material suitable for use on a smoker and capable of withstanding exposure to heat generated by combustion of a fuel source during cooking. In some such embodiments, temperatures within the cooking apparatus may be maintained at 600° F. or higher, but lower temperatures may be maintained as well for some applications. In some aspects, the operating temperature within the hamper can be approximately equal to the ignition and/or combustion temperatures of the fuel source, which can be as high as 1,292° F. or higher, for some fuel sources.

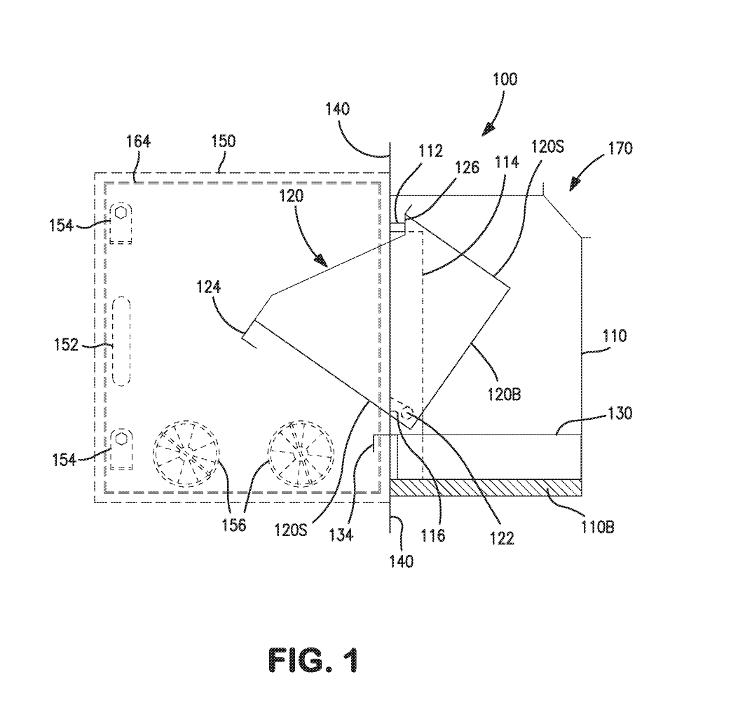

Referring now to the figures (hereinafter, “FIGS.”) provided herein for purposes of illustration of an example embodiment, and not limitation, FIGS. 1 through 4 are side and front views of an example fuel source combustion assembly.

Referring to FIG. 1, which is a schematic illustration of a fuel source combustion assembly, generally designated 100, from a cross-sectional side view. As depicted in FIG. 1 the assembly includes a housing 110, with a hamper, generally designated 120, rotatably and/or pivotably affixed to housing 110 by hinge pins 122 configured to be inserted into a slot 116 (e.g., a hinge slot) of two hinge support members 114, which are located on respective internal sides of housing 110. As can be seen, hamper 120 has, on a front upper edge, a handle 124 configured to allow a user to grasp and pull, via a pivoting or tilting movement, the hamper 120 out of the opening on the outer surface of housing 110, so that the hamper is in an open position. Hamper 120 is configured in the shape of a box or basket, having a bottom 120B and four sides 120S, with an open top. The top edges of the lateral side walls of hamper 120 are sloped or angled from the front to the rear of hamper 120, so as to accommodate the pivoting or tilting movement of hamper 120 into the open position without striking the housing before coming to the open position. Housing 110 further has an internal stop 112, which is configured to contact outward pivot stop 126 of hamper 120, preventing hamper 120 from tilting too far out of housing 110 (e.g., beyond the open position). Housing 110 has a bottom section 110B that can optionally be filled with an insulating material to direct heat from the combustion of the fuel source upwards and to prevent excess heat from being directed away from the cooking chamber (e.g., wasted, by not being used to in the cooking process). While other dimensions may be selected depending on the particular application, as will be understood by those having ordinary skill in the art, in one embodiment hamper 120 has outer dimensions of 10 in. wide, 7.7 in, deep, and 8.6 in, high, exclusive of the handle 124, inward pivot stop 128, and hinge pins 122. Larger dimensions may be employed where a hamper 120 with a larger capacity of the combustible fuel source is needed. In general, the dimensions of housing 110 and other components of assembly 100 will be modified along with the dimensions of hamper 120, such that if hamper 120 is made larger, housing 110 and other parts of assembly 100 must be made at least large enough to accommodate the increased dimensions of hamper 120.

Located underneath hamper 120 is an ash pan 130, which is slidably inserted into a lower portion of housing 110, which is located vertically underneath the upper portion of housing 110 in which hamper 120 is located. While the movement of ash pan 130 is shown as being independent of the pivoting or tilting movement of hamper 120, in some embodiments it is contemplated that a linkage may be provided by which a pivoting movement of hamper 120 will induce a corresponding linear movement of ash pan 130. Ash pan 130 has, on its front upper edge, a handle 134 configured to allow a user to grasp and slidably extract ash pan 130 out of the front of housing 110. Ash pan 130, as well as the other structures associated therewith and described hereinabove, may be omitted entirely in some embodiments.

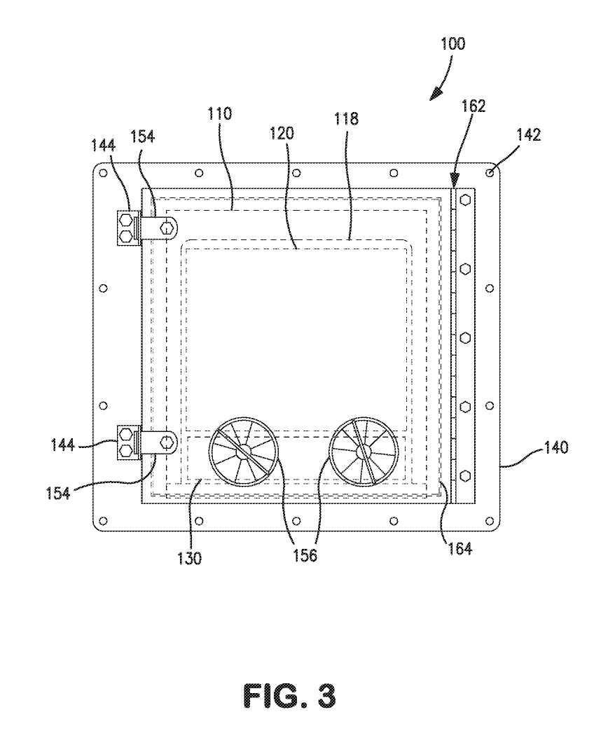

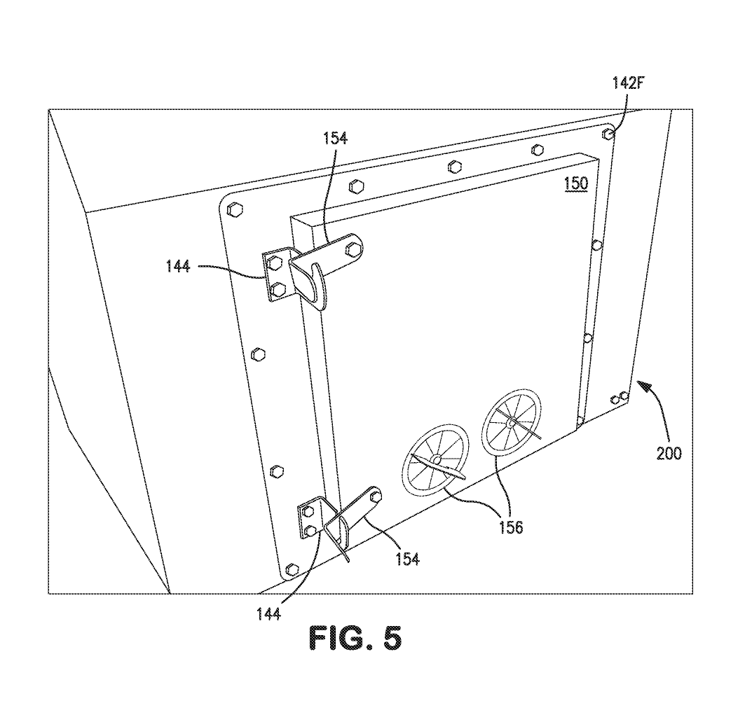

Still referring to AG. 1, housing 110 is mounted to an outer frame 140. An exhaust port 170 is disposed at an upper rear corner of housing and is configured to direct a flow of combustion gases and heat to escape from hamper 120 into a cooking chamber of the cooking apparatus (see, e.g., FIGS. 5 through 9). The assembly includes an outer door 150 configured to be mounted on outer frame 140, covering the opening through which hamper 120 is accessible. Door 150 has a plurality of louvered vents 156 formed in a bottom portion of door 150. While two vents 156 are shown, any number, including one, of vents may be used in order to control an air flow therethrough. Door 150 is mounted to the outer frame by a hinge 162 (see, e.g., FIG. 3) by bolting, screwing or otherwise affixing door 150 to frame 140, which is configured as an external wall (e.g., a side wall) of the cooking apparatus.

Door 150 has a gasket 164 made of a sufficiently compliant material capable of withstanding the elevated operating temperatures present at assembly 100 and forming a substantially air-tight seal around the perimeter of door 150 (e.g., any suitable location on the internal surface of door 150 that is adjacent to frame 140 in the closed position). By including such a sealing gasket 164, the air flow into assembly 100 can be controlled substantially entirely by manipulation of louvers 156. In other embodiments, gasket 164 can be located on an external surface of frame 140, so as to be sealingly engaged by moving door 150 into the closed position. It is further envisioned that gasket 164 may be located on both door 150 and frame 140.

Hinge 162 is attached such that door 150 can move between the open and closed positions (e.g., be opened and closed) by, for example, a swinging motion. Hinge 162 is shown in a fashion of a “piano” type hinge, but can be of any suitable type capable of supporting the weight of door 150.

Door 150 has a handle 152 which aids a user in moving door 150 from the open position to the closed position, and vice-versa. When door 150 is in the open position, hamper 120 can be accessed and folded outward to load additional amounts of the fuel source therein. Door 150 is secured in a closed position by latches 154, which can be of any suitable configuration. Door 150, as well as the other structures associated therewith and described hereinabove, may be omitted entirely in some embodiments.

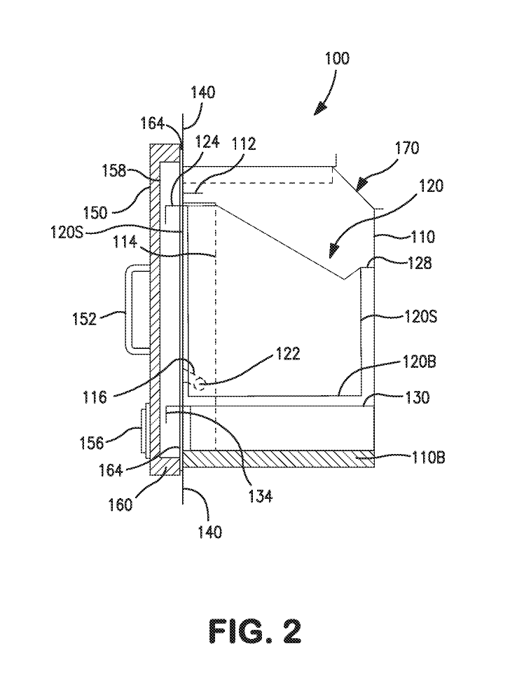

Referring now to FIG. 2, the fuel source combustion assembly 100 of FIG. 1 is illustrated, but the components thereof are arranged in a closed position. As is shown therein, housing 110 is configured substantially identically, with hamper 120 being rotatably attached to housing 110 by hinge pins 122, but hamper 120 is in the closed position. In the closed position, inward pivot stop 128 is configured to contact a back wall of housing 110 to prevent a further inward rotation beyond this point of contact. Handles 124 and 134 protrude through the opening of housing 110, into a recessed cavity of door 150 by an inner surface 158 thereof. An inside of door 150 can include insulation 160 to reduce a temperature of the exterior of door 150 during operation. It is further illustrated the position of gasket 164 to form a seal around the perimeter of door 150 at frame 140. Bottom 120B of hamper 120 is configured to have one or more perforations and/or holes in order to allow combustion remnants (e.g., ashes) to fall from hamper 120 into ash pan 130, as well as to allow an air flow, passing through vents 156 of door 150, and over combustible fuel source.

FIG. 3 is a front external view of the assembly 100 of FIGS. 1 and 2, showing door 150 in a closed position. The outline of housing 110, housing opening 118, hamper 120, and ash pan 130 are shown in broken lines. In FIG. 3, hinge, generally designated 162, is clearly shown, being hinged on a right side of door 150 and attached to outer frame 140. Any type of hinge 162 is contemplated. Outer frame 140 has a plurality of frame mounting holes 142 for mounting outer frame 140 onto a cooking apparatus. Opposite from hinge 162 are latches 154, which are configured to secure door 150 in the closed position, thereby engaging gasket 164 of door 150 against frame 140 by engaging with corresponding latch anchors 144, secured to outer frame 140. The positions of hinge 162 and the latches 154 and latch anchors 144 may be switched to positions opposite those illustrated herein. Furthermore, latches 154 and latch anchors 144 may be disposed along a top or bottom edge of door 150. Indeed, latches 154 and latch anchors 144 may be disposed in any location suitable for securing the door in a closed position, as would be readily apparent to those having ordinary skill in the art. Door 150 includes two vents 156 to allow and control air flow into the cooking apparatus and, particularly, into housing 110 where hamper 120 resides. In some embodiments vents 156 or shutters can be located at one or more other locations on the cooking apparatus (see, e.g., 200, FIGS. 5 through 9) and/or assembly 100 to control air flow into the cooking apparatus. Vents 156 are shown as a sliding rotary type of vent, but any suitable type of vent is contemplated.

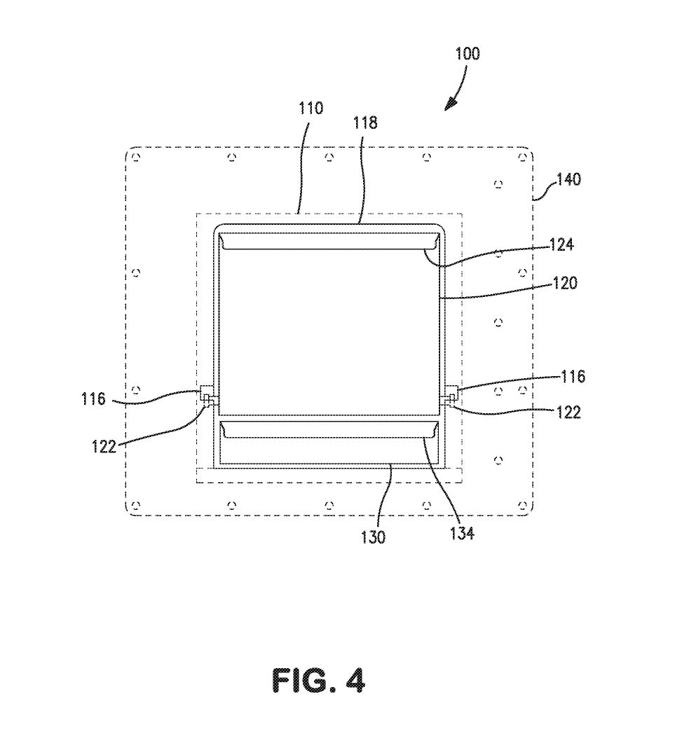

FIG. 4 is an external view of assembly 100, with door 150, as well as the other components directly affixed thereto, omitted to better illustrate the spatial relationship between housing 110, housing opening 118, hamper 120, ash pan 130, and outer frame 140. The arrangement of these components matches that shown in FIGS. 1 and 3. In this illustration, it can be seen that each hinge pin 122 is installed so as to be captive within a respective slot 116.

FIG. 5 is an illustration of a cooking apparatus, generally designated 200, with a fuel source combustion assembly 100, as shown in FIGS. 1-4 installed, with door 150 being in the closed position, secured by latches 154 and latch anchors 144. Outer frame 140 is secured to cooking apparatus 200 using fasteners 142F, which can include, for example, bolts, screws, rivets, welds, solder, and the like. Hamper 120, hidden by door 150 in the closed position shown herein, resides in an opening in outer frame 140, and is only accessible by opening door 150.

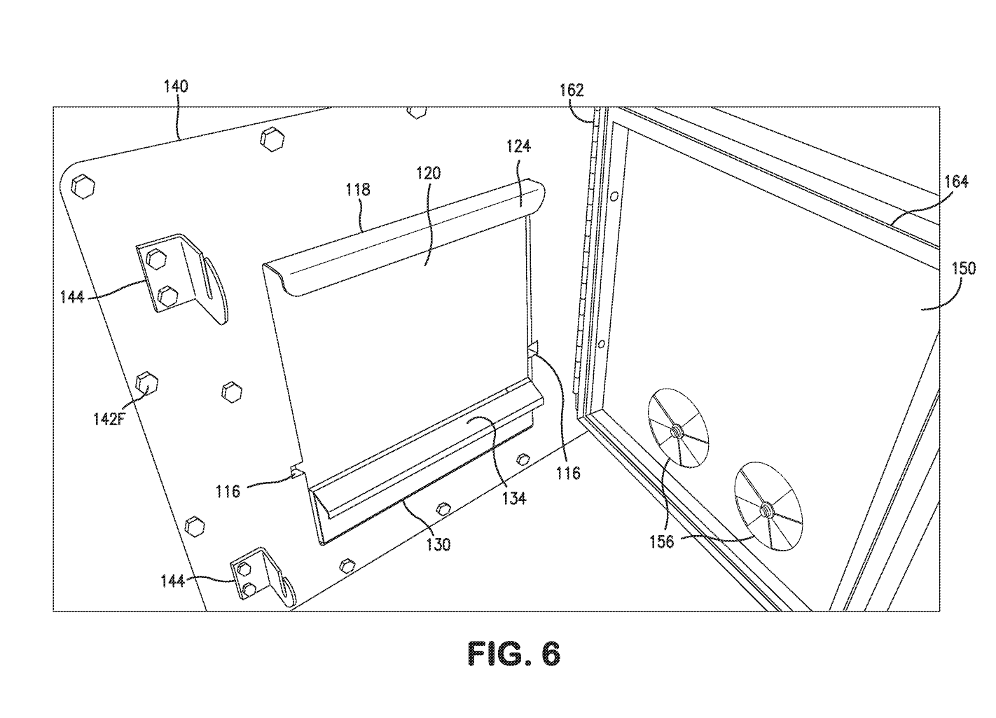

FIG. 6 is a perspective view of cooking apparatus 200, corresponding to the view in FIG. 5, but with door 150 in the open position, so compliant gasket 164 is visible, and hamper 120 in the closed position. During use, a user of the cooking apparatus 200 can grasp handle 124 of hamper 120 and pull in an outward and/or downward direction in order for the fuel source to be replenished or otherwise tended to. Similarly, handle 134 of ash pan 130 can be grasped an pulled out straight towards the front of assembly 100, so that ash pan 130 can be removed and any debris (e.g., combustion remnants) can be disposed of safely.

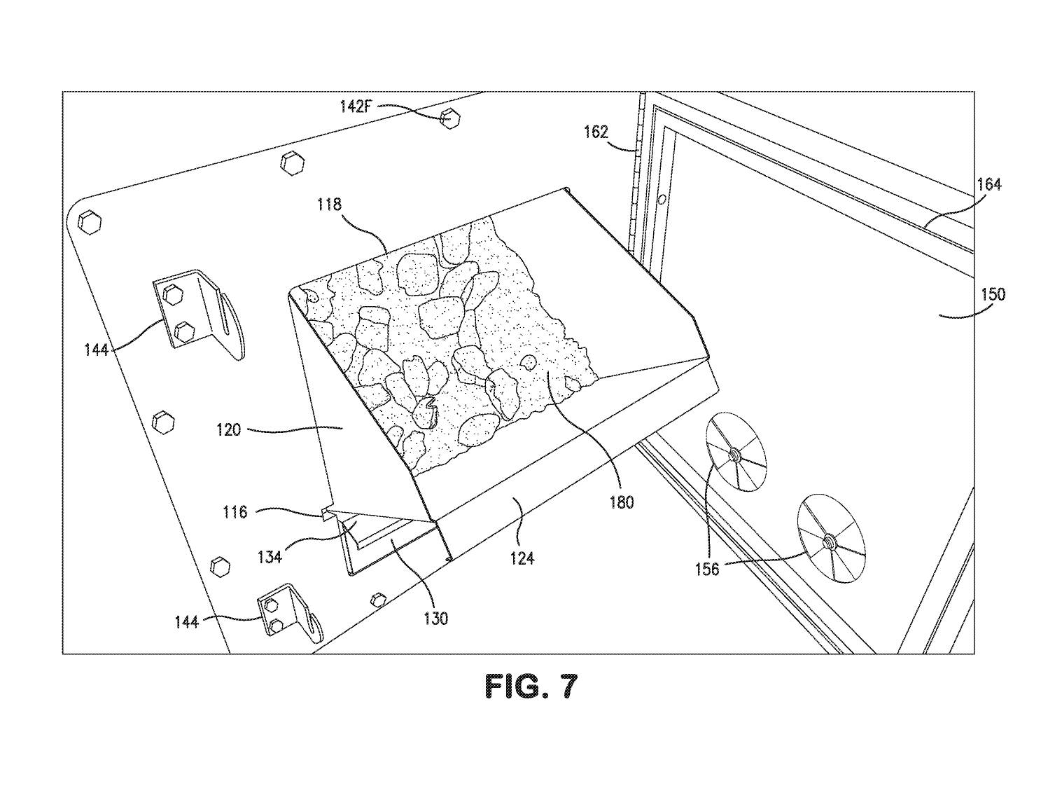

FIG. 7 is a perspective view of cooking apparatus 200, corresponding to the view in FIG. 6, but with both door 150 and hamper 120 in the open position. During use, a user can open door 150 and tilt open hamper 120 to add a fuel source 180, including even hot or pre-ignited charcoal, to hamper 120. By providing such a hamper 120 that pivots outwardly from housing 110 and/or cooking apparatus 200, the user can easily and safely add a pre-ignited fuel source, such as charcoal, an example of such addition including pouring the pre-ignited fuel source from a chimney charcoal starter, by simply pouring it into hamper 120. Hamper can then be tilted back to the closed position to thereby secure fuel source 180 inside cooking apparatus 200. Door 150 can then be closed, pressing gasket 164 between door 150 and frame 140, and secured via the one or more latches 154. In the closed position, door 150 covers hamper 120 and housing opening 118, through which it can be tilted open. Opening or closing vents 156 controls the air flow to hamper 120 and/or housing 110.

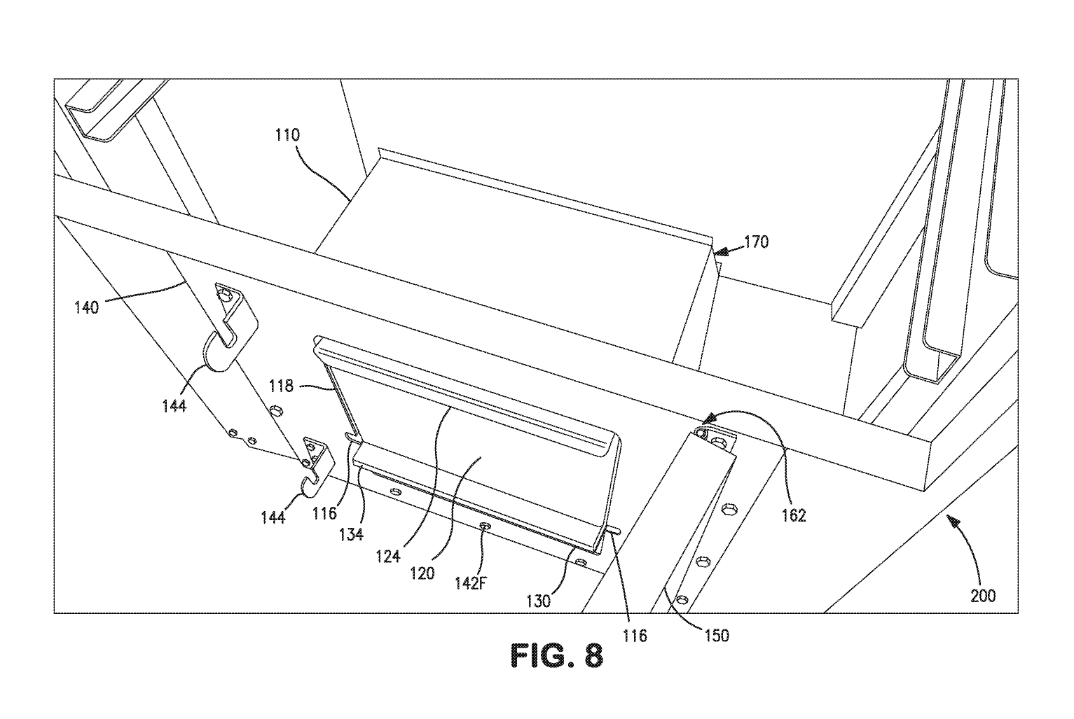

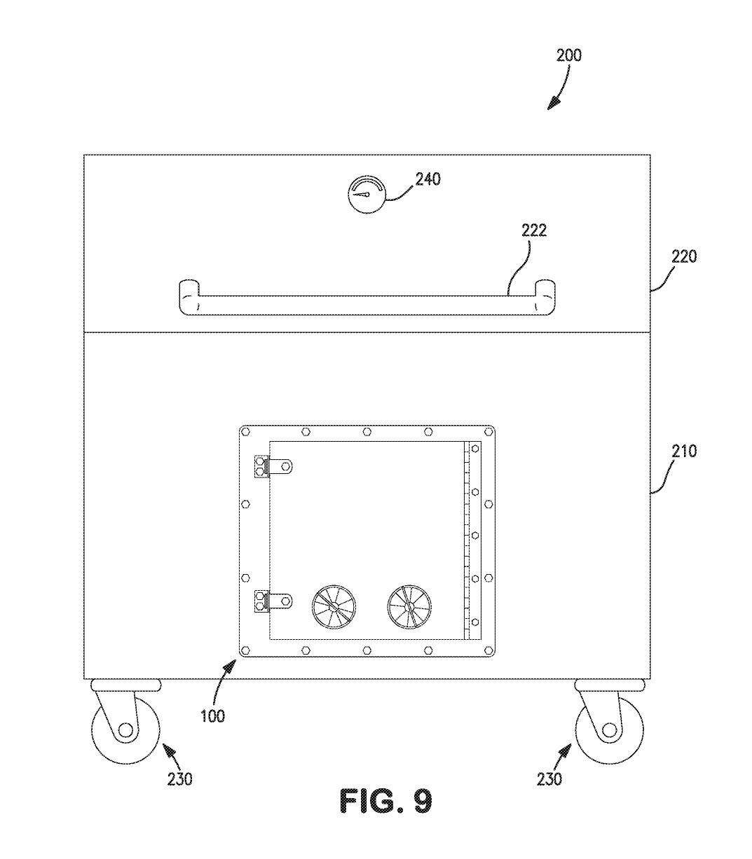

FIG. 8 is a perspective view of an interior view of a cooking apparatus 200 with an assembly 100 installed therein, the illustration showing door 150 in the open position and hamper 120 in the closed position. As depicted in FIG. 8, hamper 120 is mounted within housing 110, which is mounted on an outer surface or side wall of cooking apparatus 200, so as to extend to the interior of cooking apparatus 200 so as to provide a container to hold the fuel source for combustion during use of the smoker. Hamper 120 is mounted in housing 110, housing 110 being arranged so as to reside entirely or substantially inside the cooking apparatus 200, as shown in FIG. 6. In some embodiments housing has an exhaust port 170 disposed, for example, at the top and back of housing 110, as shown in FIG. 6, which is configured to allow the combustion gases (e.g., smoke) and heat generated during combustion of the fuel source to escape from assembly 100, inside housing 110, into a cooking chamber (e.g., 220, FIG. 9) of cooking apparatus 200. Exhaust port 170 is positioned to direct the heat and smoke to a desired location within cooking apparatus 200 to optimize cooking and/or smoking of the contents (e.g., meat) of the cooking apparatus.

Referring now to FIG. 9, a cooking apparatus, generally designated 200, is shown, cooking apparatus 200 including a fuel source combustion assembly 100, which is substantially similar to the assemblies shown in FIGS. 1 through 8. Cooking apparatus 200 is shown herein as being a barbecue grill; however, any type of cooker, including a smoker, an indoor cooker, and an outdoor cooker is contemplated. Cooking apparatus 200 has a lower portion 210, in which assembly 100 is installed, and a cooking chamber 220 above the lower portion. The interior of the cooking chamber 220 is accessible via manipulation of handle 222, and the temperature within cooking chamber 220 is monitored by a temperature sensor 240. Cooking apparatus 200 is shown as being movable by wheels 230 connected to cooking apparatus 200 at lower portion 210. While assembly 100 is shown being installed on a front of cooking apparatus 200, it can be installed in any suitable position, including a side or rear of cooking apparatus 200.

A method of loading a combustible fuel source into a fuel source combustion assembly (see, e.g., assembly 100 of FIGS. 1 through 4) installed in a cooking apparatus (see, e.g., FIGS. 5 through 9) is provided herein. According to this method, a cooking apparatus, which has a fuel source combustion assembly, is provided, wherein the fuel source combustion assembly comprises a hamper configured to receive and contain a combustible fuel source; and a housing, which at least partially surrounds the hamper, the housing comprising an opening on an external surface thereof, through which the hamper is accessible. A first step of the method includes rotating and/or tilting the hamper from a first position to a second position, wherein the hamper, during the rotating and/or tilting, passes at least partially through and out of the opening by rotating and/or tilting about a hinge axis defined by one or more hinge points by which the hamper is rotatably connected to the housing. A second step of the method includes loading the combustible fuel source into the hamper. A third step includes rotating and/or tilting the hamper from the second position to the first position.

In other embodiments, the method includes further steps, including opening, before rotating and/or tilting the hamper from the first position to the second position, a door so that the opening of the housing is accessible by a user; and closing, after rotating and/or tilting the hamper from the second position to the first position, the door so that the opening of the housing is substantially entirely covered by the door. In this embodiment, the door is disposed on an external surface of the housing of the assembly and/or the cooking apparatus.

In still other embodiments, the method can include removing an ash pan; discarding any combustion remnants of the fuel source from the ash pan; and inserting the ash pan. In this embodiment, the hamper has a bottom surface with perforations or openings formed therein, such that the combustion remnants are able to pass from the hamper into the ash pan.

In another embodiment, the method is performed on an assembly with a door, which has one or more door vents disposed therein, that is disposed on an external surface of the housing of the assembly and/or cooking apparatus, with the one or more door vents being configured to control an air flow to the fuel source when the door is in a closed position.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A fuel source combustion assembly for use in a cooking apparatus, the assembly comprising:
a hamper configured to receive and contain a combustible fuel source therein;
a housing configured to at least partially surround the hamper, the housing comprising an opening on an external surface thereof, wherein the hamper is accessible via the opening; and
a door disposed on an external surface of the housing and configured to move between an open position and a closed position with respect to the housing and hamper, wherein, when the door is in the closed position, the opening in the housing is substantially entirely covered by the door and, when the door is in the open position, the hamper is accessible to a user through the opening in the housing,
wherein the hamper is mounted to the housing at one or more hinge points, and
wherein at least a portion of the hamper is configured to tilt through and out of the opening in the housing by rotating, with respect to the housing, at the one or more hinge points.

2. The assembly of claim 1, wherein the hamper has a shape of a box with an at least partially open top, the hamper comprising a bottom and four sides.

3. The assembly of claim 2, wherein the bottom of the hamper comprises perforations or openings configured for air to flow therethrough to the fuel source and for combustion remnants of the fuel source to fall therethrough out of the hamper.

4. The assembly of claim 3, comprising an ash pan located below the hamper, wherein the ash pan is configured to catch combustion remnants of the fuel source falling from the hamper through the perforations or openings in the bottom thereof.

5. The assembly of claim 4, wherein the ash pan is configured to be removed by a sliding movement for disposal of the combustion remnants accumulated in the ash pan.

6. The assembly of claim 1, wherein the assembly is mounted on an outer surface of a cooking apparatus, the assembly extending into an interior of the cooking apparatus to direct heat or smoke generated by combustion of the fuel source to the interior of the cooking apparatus.

7. The assembly of claim 6, wherein the housing is located at least substantially entirely inside the cooking apparatus.

8. The assembly of claim 1, wherein the housing comprises at least one hinge support with a hinge slot, the hinge slot being configured to receive a hinge pin of the hamper, wherein the one or more hinge points are substantially aligned with the hinge slot of each of the at least one hinge support.

9. The assembly of claim 1, wherein the housing comprises an exhaust configured to direct a flow of combustion gases and heat from the hamper into a cooking chamber of the cooking apparatus.

10. The assembly of claim 1, further comprising an outer frame, to which the door is mounted, wherein the outer frame is configured to be mounted to an outer surface of the cooking apparatus.

11. The assembly of claim 10, wherein the door comprises a gasket around a perimeter of the door, so as to form at least a partial seal between the door and the frame, and wherein the door is attached to the outer frame, such that the door moves between the open position and the closed position in a swinging motion.

12. The assembly of claim 1, wherein the hamper is accessible to a user by a tilting movement, about the one or more hinge points, of the hamper through the opening of the housing.

13. The assembly of claim 1, wherein the hamper is configured to receive a fuel source that is already combusting.

14. The assembly of claim 1, wherein the door comprises one or more door latches to secure the door in a closed position.

15. The assembly of claim 1, wherein the door comprises one or more door vents to control air flow into the hamper.

16. The assembly of claim 1, comprising:
perforations or openings in a bottom of the hamper, wherein the perforations or openings are configured for air to flow therethrough to the fuel source;
an ash pan located below the hamper, wherein the ash pan is configured to catch combustion remnants of the fuel source falling from the hamper through one or more perforations or openings in the bottom thereof;
an outer frame, to which the door is mounted, wherein the outer frame is configured to be disposed on an outer surface of the cooking apparatus; and
one or more door vents in the door,
wherein the ash pan, door, door vents, or outer frame comprise a material selected from a group consisting of a metal alloy, aluminum, steel, cast iron, stainless steel, any material capable of withstanding exposure to heat generated by combustion of the fuel source, and combinations thereof.

17. A cooking apparatus comprising:
at least one assembly of claim 1; and
at least one cooking chamber configured to cook or smoke a food product placed therein,
wherein the at least one assembly is configured to direct heat or smoke generated by combustion of the fuel source into the at least one cooking chamber.

18. The cooking apparatus of claim 17, wherein the at least one assembly is mounted on an outer surface of the cooking apparatus to extend into an interior of the cooking apparatus.

19. The cooking apparatus of claim 17, wherein the cooking apparatus comprises a smoker, a barbecue grill, an outdoor cooker, or an indoor cooker.

20. A hamper configured to receive and contain a combustible fuel source therein, the hamper comprising:
a shape of a substantially square or rectangular shaped box with an at least partially open top;
a bottom with perforations or one or more openings configured for air to flow therethrough to the fuel source and for combustion remnants of the fuel source to pass therethrough out of the hamper;
four side walls connected to the bottom; and
two hinge pins mounted on the container so the container is rotatably connectable to a cooking apparatus.

21. The hamper of claim 20, wherein the two hinge pins define a hinge axis, around which the hamper rotates or tilts outward from the cooking apparatus.

22. A method of loading a combustible fuel source into a cooking apparatus, the method comprising:
providing a cooking apparatus, which has a fuel source combustion assembly, wherein the fuel source combustion assembly comprises:
a hamper configured to receive and contain a combustible fuel source; and
a housing configured to at least partially surround the hamper, the housing comprising an opening on an external surface thereof, through which the hamper is accessible;
rotating or tilting the hamper from a first position to a second position, wherein the hamper, during the rotating or tilting, passes at least partially through and out of the opening by rotating or tilting about a hinge axis defined by one or more hinge points by which the hamper is rotatably connected to the housing;
loading the combustible fuel source into the hamper; and
rotating or tilting the hamper from the second position to the first position.

23. The method of claim 22, comprising:
moving, before rotating or tilting the hamper from the first position to the second position, a door from a closed position to an open position, so that the opening of the housing is accessible by a user; and
moving, after rotating or tilting the hamper from the second position to the first position, the door from the open position to the closed position, so that the opening of the housing is substantially entirely covered by the door,
wherein the door is disposed on an external surface of the housing or cooking apparatus.

24. The method of claim 22, comprising:
removing an ash pan;
discarding any combustion remnants of the fuel source from the ash pan; and
inserting the ash pan,
wherein the hamper has a bottom surface with perforations or openings formed therein, such that the combustion remnants pass from the hamper into the ash pan.
